(19) United States
(12) Patent Application Publication
(10) Pub. No.: US 2009/0205791 A1
(43) Pub. Date: Aug. 20, 2009

(54) Support assembly for a curtain/shade

(76) Inventor: Jose M Sans Folch, Montblanc (ES)

Correspondence Address: MALLOY & MALLOY, P.A., 2800 S. W. Third Avenue, Historic Coral Way, MIiami, FL, 33129, US

(21) Appl. No.: 12/231,997

(22) Filed: Sep. 8, 2008

(30) Foreign Application Priority Data
Feb. 14, 2008 (ES) 200800401

(51) Int. Cl. E06B 9/24

(52) U.S. Cl. 160/368.1

(57) ABSTRACT

A support assembly for hanging a curtain/shade such as a chain curtain including a plurality of elongated chain link strings in depending, adjacent relation. A mounting assembly includes an elongated rail having a plurality of at least two elongated chambers disposed within the hollow interior of the rail. A support assembly includes at least one elongated support member having a head portion and a leg portion disposable in a non-exposed, operative position comprising the leg portion connected in supporting relation to the plurality of chain link strings and the head portion disposed within a correspondingly dimensioned and configured one of the two chambers. The leg portion includes an apertured construction comprising a plurality of spaced apart apertures each disposed to engage and support a different one of the plurality of chain link strings of the supported curtain/shade.

### CLAIM OF PRIORITY

A claim of priority pursuant to 35 U.S.C. Section 119 is hereby made to an application for an industrial design filed by myself in Spain, namely that having Serial No. 200800401 and filed on Feb. 14, 2008, which application is currently pending.

### BACKGROUND OF THE INVENTION

1. Field of the Invention

This invention is directed to a support assembly for connecting and supporting a chain curtain/shade or similar structure in a predetermined location. A mounting rail includes a plurality of elongated chambers along the length thereof for receipt and support of at least one support member structured to be connected on the interior of the mounting rail in a visually non-exposed position. The mounting rail supports the curtain/shade such that the elongated chain link strings or other components of the curtain/shade depend therefrom in side-by-side relation to one another.

2. Description of the Related Art

The use of various types of support assemblies for curtains, shades, etc. are well known and are generally structured to support the curtain or shade, and the various components associated therewith, in a depending relation from a ceiling, wall or the like. As such, the various components of conventional or known curtain support assemblies are structured in a manner which necessarily exposes certain working parts of the support assembly as they support the curtain in depending relation from the ceiling, wall or other structure. In addition, many of the known curtain support assemblies require that significant structural modifications be made to the ceiling, wall or the like from which the curtain or shade is being supported. Such structural modifications may include the forming of holes, grooves, channels or like mounting installations which are specifically adapted to be connected to and support the conventional support assembly in a manner which further facilitates the depending orientation of the curtain or shade therefrom.

Examples of support assemblies for curtains, shades, etc. are disclosed in my foreign applications including Industrial Models No. 75480A-B and User Models U9103399 and U9103534. While operative for their intended function, the inventions disclosed in the above noted foreign applications are not structured to hide or otherwise dispose various working components of the support assembly in a non-exposed or non-observable location. As should be apparent, the positioning or orienting of the structural components of a preferred support assembly would substantially prevent the viewing or observation of the working components, thereby adding to the overall decorative or aesthetic features of a curtain or shade support assembly. In addition, my foreign User Model No. U9002126 is an additional example of a support assembly structured to include a top longitudinal beam for the supported curtains but which may be considered too heavy or otherwise structurally inappropriate for many specific applications.

Therefore, there is a need in this area for a support assembly for a curtain, shade or like structure. In particular, a preferred and proposed support assembly should also be structurally and operationally adapted to support a chain type curtain or shade of the type which includes a plurality of elongated strings each of which are formed from a plurality of interconnected, successively disposed chain links. As such, the plurality of chain link strings may be independently connected to the support assembly so as to collectively define a depending array of a plurality of strings in immediately adjacent side by side relation to one another.

Further, a preferred and proposed support assembly would include various operative and structural features necessary for the stable support and possible positioning of the aforementioned type of curtain or shade in an intended operative position. Such operative position is further defined by disposing significant portions of the supporting components in a visually, non-exposed position. As such, the decorative and aesthetic features of such a preferred support assembly would be significantly enhanced.

### SUMMARY OF THE INVENTION

The present invention is directed to a support assembly for hanging a curtain or shade and in particular, a “chain-type” curtain or shade. However, it is noted that the support assembly of the present invention is not limited to the depending support of chain-type curtains. For purposes of clarity a chain curtain or shade may be characterized by a plurality of elongated strings of chain links connected to the support assembly such that the collective array of the plurality of chain link strings will be disposed in immediately adjacent relation to one another but be movable relative to one another. Clearly, the length of the elongated strings may vary, wherein the collective plurality of strings may or may not have a substantially common length sufficient to cover or overlie a window, door, portal or other selected area.

In the various preferred embodiments of the support assembly of the present invention, included structural and operative features are such that chain curtains or shades of different weights may be supported or hung as intended. Further, the various preferred embodiments of the support assembly are such that certain structural and operative components thereof are disposed in a visually non-exposed position on the interior of a mounting assembly which defines part of the support assembly. Therefore, the overall decorative and aesthetic features of the support assembly of the present invention may be enhanced due at least in part to the visual absence of any distracting structural components of the support assembly.

Additional features of the support assembly include its ability to be quickly and easily connected in an appropriate location such as a ceiling, wall, etc. from which a curtain, shade, etc. are normally supported. When mounted in such an appropriate position, the curtain or shade may readily assume the depending or “hanging” orientation. As such, the aforementioned mounting assembly associated with the various embodiments of the support assembly of the present invention does not require any structural modification or variance of the supporting ceiling, wall, etc. to which it is connected and from which it is supported.

More specifically, the various embodiments of the support assembly include a mounting assembly structured to be connected to a ceiling, wall or other stable, substantially conventional supporting surface and including an elongated mounting rail. The mounting rail includes a hollow interior extending along substantially the entire length thereof, wherein the hollow interior is defined by a plurality of at least two elongated chambers, also extending along the length of the rail. The support assembly further includes at least one elongated support member disposable in an operative position within the hollow interior. The operative position is at least partially defined by the support member disposed in a substantially visually non-exposed position within the mounting rail. In addition, when in its operative position the support member is disposed within and supported by the structure associated with at least one of the plurality of chambers, wherein the two adjacent chambers are disposed in communicating relation with one another. As such, the one support member includes a head portion and a leg portion. The head portion is disposed within a correspondingly dimensioned and configured one of the plurality of at least two elongated chambers. Further defining the operative position of the support member is the leg portion, extending into the adjacent one of the chambers. The leg portion preferably includes the apertured construction which facilitates removable or fixed connection of the various elongated link strings of the chain curtain to the leg portion such that they collectively depend there from, such as by being “hung” in a depending fashion in a somewhat conventional orientation. It is emphasized however that when the curtain or shade is not of the chain-type structure, other structural components associated with the curtain or shade may be connected to and supported by the apertured construction of the leg portion.

As set forth above, the plurality of at least two chambers are disposed in communicating relation with one another so as to facilitate the mounting and support of the head portion of the support member in a corresponding one of the two chambers. Concurrently, the leg portion thereof extends into the other of the two adjacent and communicating chambers where it is connected in supporting relation to the various components of the curtain or shade being supported. As such, the head portion, the leg portion as well as the apertured construction which facilitate connection to the curtain or shade are not visually exposed and therefore not observable from an exterior of the mounting rail. Accordingly the exterior of the mounting rail is currently observable and as such includes outwardly disposed lateral side walls preferably having a convex curve or other configuration which adds to the overall aesthetic and decorative features of the support assembly.

Again with primary reference to the at least two communicating and adjacent chambers within the mounting rail, the second of these chambers is somewhat enlarged relative to the first chamber and as such is structurally and dimensionally adapted to receive a somewhat conventional auxiliary support member therein. Such an auxiliary support member is disposable within the second elongated chamber in the absence of the primary or first mentioned support member being disposed in the smaller first chamber within the hollow interior of the mounting rail. Accordingly, when the auxiliary support member comprises a carriage type support, the curtain or shade may be reciprocally positionable along the length of the mounting rail in a manner which is known in this art.

Other features associated with the support assembly and in particular the mounting rail, include an upper open channel and a lower open channel respectively disposed and configured to receive a connecting assembly and to allow placement or passage of the supported curtain therethrough. Attachment of the mounting rail to the aforementioned connector assembly is thereby accomplished in an efficient manner and does not require any structural modification of the supporting ceiling, wall, etc.

Therefore, the support assembly of the present invention, including the various preferred embodiments to be described in greater detail hereinafter, overcomes many of the disadvantages and problems associated with conventional and/or known support assemblies of the type intended to support a curtain or shade in a hanging, depending orientation. For purposes of clarity it is further emphasized that the term “curtain” or “shade” are used herein in a broad sense and are meant to encompass a variety of different curtains, shades, wall or window coverings, etc. of the type which are normally supported in a “hanging” orientation and in overlying or covering relation to a window, door, portal or any of a variety of different areas for purposes of blocking out exterior light and/or for decorative and aesthetic purposes.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a perspective view in partial cutaway of a mounting assembly in the form of a mounting rail.

FIG. 2 is an end view of the embodiment of FIG. 1.

FIG. 3 is a perspective view of a support assembly comprising an elongated support member.

FIG. 4 is an end view of the embodiment of FIG. 3.

FIG. 5 is a perspective view in partial cutaway in phantom of an assembled support assembly including the structural components of the embodiments of FIGS. 1-4.

FIG. 6 is an end view of the embodiment of FIG. 5.

FIG. 7 is a perspective view in partial cutaway in phantom of yet another embodiment of the present invention utilizing a carriage type support member in the absence of the support member of the embodiment of FIG. 3.

FIG. 8 is an end view of the embodiment of FIG. 7.

FIG. 9 is a perspective view in partial cutaway and phantom of the embodiment of FIG. 8 further including a cover assembly.

FIG. 10 is an end view of the embodiment of FIG. 9.

FIG. 11 is a composite front and sectional view of an end cap disposed in attached, covering relation to the open ends of the support rail of the type represented in the embodiments of FIGS. 1-10.

FIG. 12 is a perspective interior view of the embodiment of FIG. 11.

FIG. 13 is a perspective view in partial cutaway and phantom of yet another embodiment of the mounting assembly of the present invention similar but distinguishable from the embodiment of FIGS. 1-10.

FIG. 14 is an end view of the embodiment of FIG. 13.

FIG. 15 is a perspective view of yet another preferred embodiment of a support assembly including at least one support element.

FIG. 16 is an end view of the embodiment of FIG. 15.

FIG. 17 is an assembled view of the support assembly including the structural components set forth in the embodiments of FIGS. 13-16.

FIG. 18 is an end view of the embodiment of FIG. 17.

FIG. 19 is a perspective view in partial cutaway in phantom of yet another preferred embodiment of the present invention including a carriage type support member in the absence of the support member as represented in FIG. 15.

FIG. 20 is an end view of the embodiment of FIG. 19.

FIG. 21 is a perspective view in partial cutaway in phantom including a cover assembly associated with the embodiment of FIGS. 19 and 20.

FIG. 22 is an end view of the embodiment of FIG. 21.

FIG. 23 is a composite end and sectional view of an end cap associated with the mounting assembly of the embodiment of FIGS. 21 and 22.

FIG. 24 is a perspective interior view of the embodiment of FIG. 23.

FIG. 25 is yet another preferred embodiment of the support assembly including at least one support member.

FIG. 26 is an end view of the embodiment of FIG. 25.

FIG. 27 is a perspective view in partial cutaway of an assembled support assembly which is partially represented by the one support member as represented in the embodiment of FIGS. 25 and 26.

FIG. 28 is an end view of the embodiment of FIG. 27.

Like reference numerals refer to like parts throughout the several views of the drawings.

### DETAILED DESCRIPTION OF THE PREFERRED EMBODIMENT

The present invention is directed to a support assembly for a curtain, shade, etc. such that the curtain or shade is disposed in a “hanging” depending orientation from any of a variety of different structures (not shown for purposes of clarity) such as a wall, ceiling, etc. The support assembly of the present invention is specifically adapted for the connection to and support of a “chain-type” curtain or shade generally indicated as 17 in the accompanying Figures. As such, the chain curtain or shade includes a plurality of elongated strings 16 each formed from a plurality of successively interconnected chain links as clearly demonstrated in FIGS. 5 and 7 as well as additional, somewhat corresponding Figures included in the accompanying drawings. It is emphasized, however, that a variety of other types of curtains, shades, coverings, etc. may also be supported in an intended and aesthetically pleasing fashion utilizing the various preferred embodiments of the support assembly of the present invention.

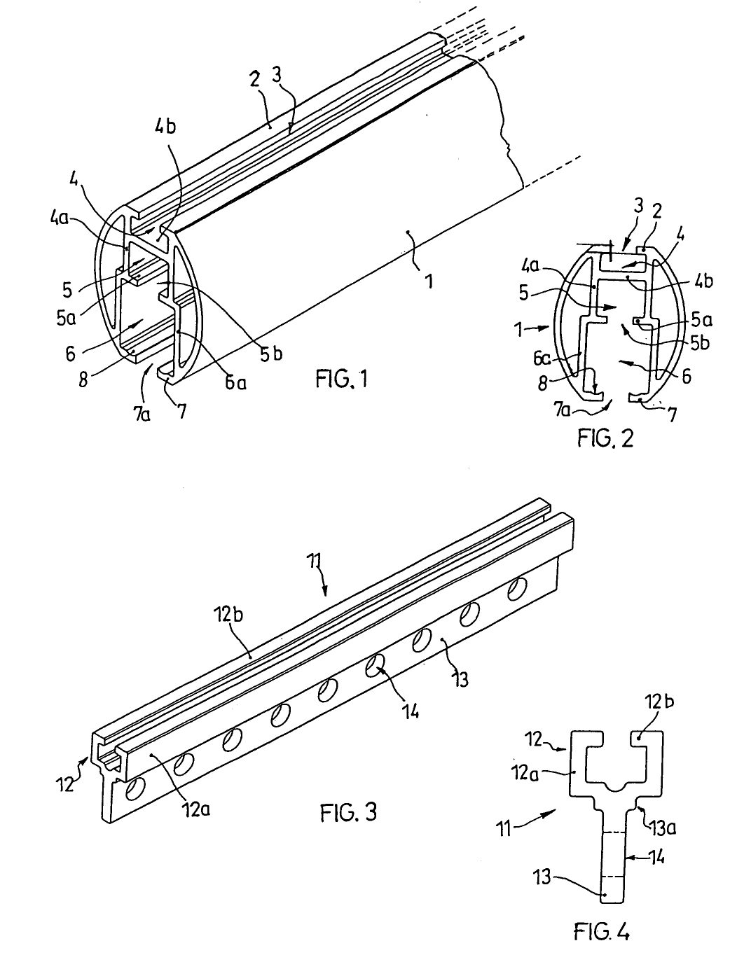

With primary reference to FIGS. 1-12, at least one preferred embodiment of the present invention includes a mounting assembly comprising an elongated mounting rail 1 having an at least partially hollow interior and curved or other preferably configured lateral side walls. As such, the mounting rail 1 comprises a generally tubular configuration, wherein the hollow configuration comprises a plurality of at least two elongated chambers 5 and 6. In addition, the mounting rail 1 includes an upper open channel 4 accessed by an elongated slot 3 disposed in communicating relation between the interior of the upper open channel 4 and an exterior of the mounting rail 1. As represented, the channel is defined by inwardly directed flanges 2 overlying and at least partially defining the boundaries of the open channel 4. The lower open channel is generally indicated as 7a and is disposed in communicating relation with the exterior of the mounting rail 1 and the interior of an adjacent elongated chamber 6 defining the aforementioned plurality of chambers.

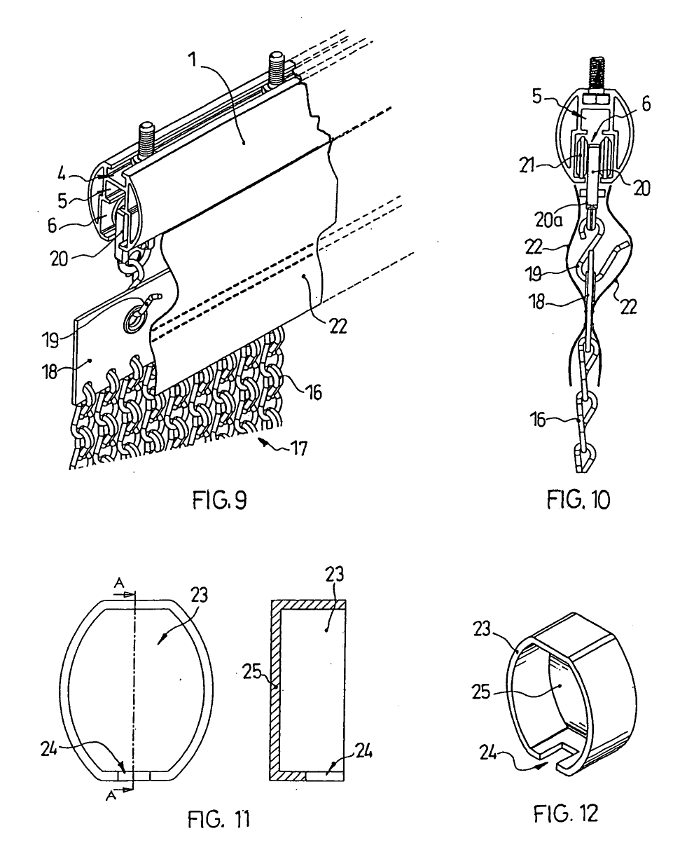

Additional structural details as evident in both FIGS. 1 and 2 include one of the chambers, as at 5, having boundaries defined by a closed partition 4b and oppositely disposed side walls 4a. An open slot 5b is defined by inwardly directed flanges 5a and establishes communication between the adjacent chambers 5 and 6. Further the lateral boundaries of the chamber 6 are defined by spaced apart inner walls 6a. As will be explained in greater detail hereinafter, elongated grooves 8 are disposed on the interior surface of the inwardly directed flanges 7 which define the open lower channel 7a. Such elongated grooves are disposed, dimensioned and configured to facilitate passage of an auxiliary support member as represented FIGS. 8 and 10.

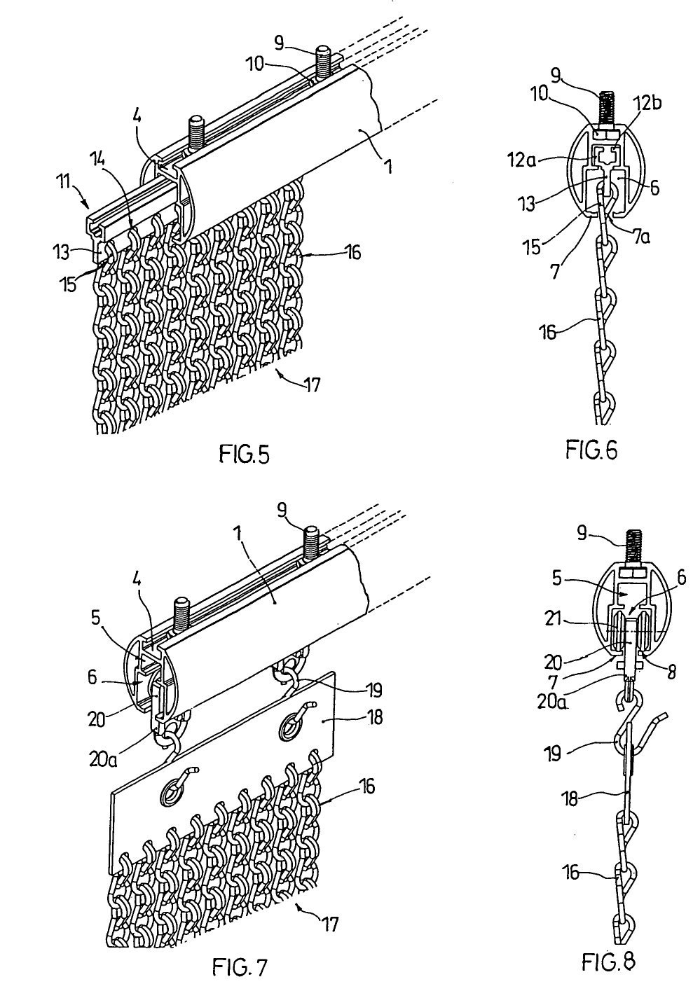

Another feature of the preferred embodiment of FIGS. 1-12 includes a support assembly comprising at least one elongated support member 11. The support member 11 includes a head portion 12 having a somewhat enlarged or expanded configuration which is fixedly connected to a leg portion 13 of the support member 11. As represented, the head portion 12 comprises lateral side portions 12a and inwardly directed flanges 12b. Further, the head portion 12 and the leg portion 13 are fixedly interconnected as at an expanded joint or junction 13a. Further, the dimension, disposition and configuration of the expanded junction 13a facilitates the connection and/or supported placement of the support member 11 and the head portion 12 into the hollow interior of the mounting rail 1 as represented in FIGS. 5 and 6.

More specifically when assembled the support member 11 is disposed within the hollow interior of the mounting rail 1 in a preferred, non-exposed, operative position. Such an operative position is more specifically defined by the somewhat enlarged head portion 12 being disposed within the correspondingly dimensioned and configured chamber 5 as such the leg portion 13 extends outwardly from the head portion 12 through the communicating slot 5B and into the interior of the adjacent, communicating compartment 6. Therefore, when in the aforementioned operative position, substantially the entire support member 11 is substantially non-exposed to the extent that it cannot be observed or viewed from the exterior of the mounting rail 1. In such position the curtain 17 and more specifically the chain link strings 16 are connected to the leg portion 13 through the provision of an apertured configuration associated with the leg portion 13.

More specifically, the apertured construction comprises a plurality of spaced apart apertures 14 formed in and passing through the leg portion 13. The plurality of apertures are each disposed, configured and dimensioned to receive a connecting, end most link 15 of each of the chained link strings 16. Therefore even the upper end defined at least partially by adjacently disposed ones of the end links 15 are also disposed in a non-exposed position when the one support member 11 is disposed within the hollow interior portion of the mounting rail 1 in its non-exposed position. The provision of the lower open channel 7a is such as to allow passage or disposition of the plurality of chain link strings 16 therethrough so that they may be oriented in the preferred “hanging” orientation as they are supported in depending relation from the leg portion 13. Further, the open upper channel 4 is structured to be connected to and supported by a connecting assembly comprising at least one, but more practically, a plurality of spaced apart connector members 9 each having an enlarged head 10. The enlarged head 10 of the plurality of connectors 9 are cooperatively dimensioned and configured with the interior dimension and configuration of the open upper channel 12 such that the heads 10 are retained therein. Concurrently, the shank of the connectors 9 are appropriately connected to and fixed on or within an appropriate supporting structure such as a ceiling, wall, etc.

With primary reference to the additional structural features as represented in FIGS. 7-10, the versatility of the support assembly is further evidenced by the fact that an auxiliary support member 20 may be utilized to support the curtain 17 in a hanging or depending relation from the mounting rail 1. Further, the auxiliary support member 20 includes a carriage type structure at least partially defined by one or more rollers 21 which are disposed to travel along the interior length of the chamber 6 by the rollers or wheels 21 engaging the aforementioned elongated grooves 8. As should be apparent the carriage type auxiliary support member 20 is used in the absence of the primary or first described cover member as clearly represented in FIGS. 3 and 4.

As emphasized above, the dimension and configuration of the chamber 5 substantially corresponds to the cross sectional dimension of the head portion 12a in order to engage and support the head portion 12 and the remainder of the support element 11 in a stable orientation while in its operative position. However, the adjacent and communicating chamber 6 has a somewhat larger cross sectional dimension and configuration from that of FIG. 5. As such it is adequate to accommodate the overall dimension and configuration of the carriage type support member 20. However, when the support member 20 is utilized, at least a portion thereof extends through the open lower channel 7a and is further structured to accommodate interconnecting hooks or like connectors 19 for removable attachment to an apertured structure associated with a belt, strap, tape, etc. 18. Therefore, in the embodiment of FIGS. 7-10 the plurality of chain link strings 16 are connected to the tape, strap, etc. 18 which in turn are connected to the hook like connectors 19 as clearly represented.

However, when the embodiment of FIGS. 7 and 8 are utilized in absence of the primary or first mentioned support element 11 disposed in its operative position, an additional modification as represented in FIGS. 9 and 10 may be the inclusion of a cover assembly generally indicated as 22. As represented, the cover assembly may include at least one but more practically two spaced apart cover members each disposed in overlying, covering relation to the strap 18, interconnecting connectors 19 and the upper end or portion of the curtain 17 which is connected to the supporting strap, band, etc. Therefore the portions of the auxiliary support element 20 extending outwardly from the hollow interior portion of the mounting rail 1 are covered and thereby also disposed in a non-exposed position or orientation so as to prevent observation of the structural and operative components associated with the additional embodiment of FIGS. 7-10.

Yet additional structural features of this embodiment includes the provision of one or more end caps including a closed end 25 and a correspondingly configured and/or curved outer side walls 23. These end caps are disposable in overlying and covering relation to the open ends of the mounting rail 1, when such is desired. The provision of a recessed groove or like structure 24 is appropriately disposed to accommodate an end of the hanging curtain 17 and/or strap 18, dependent on the embodiment and/or structural modification being utilized.

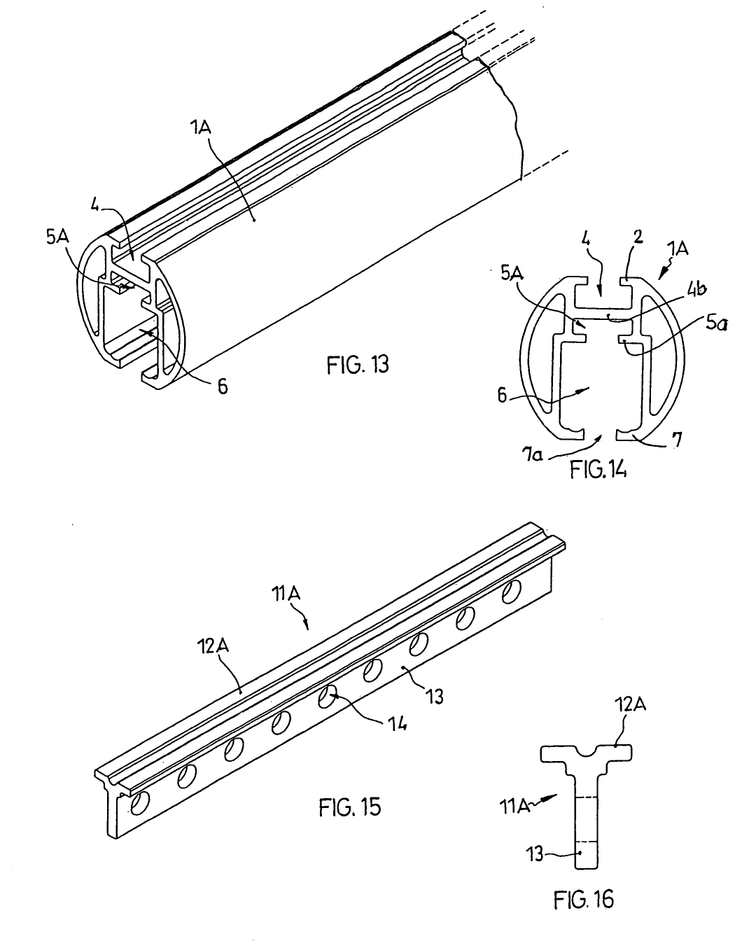

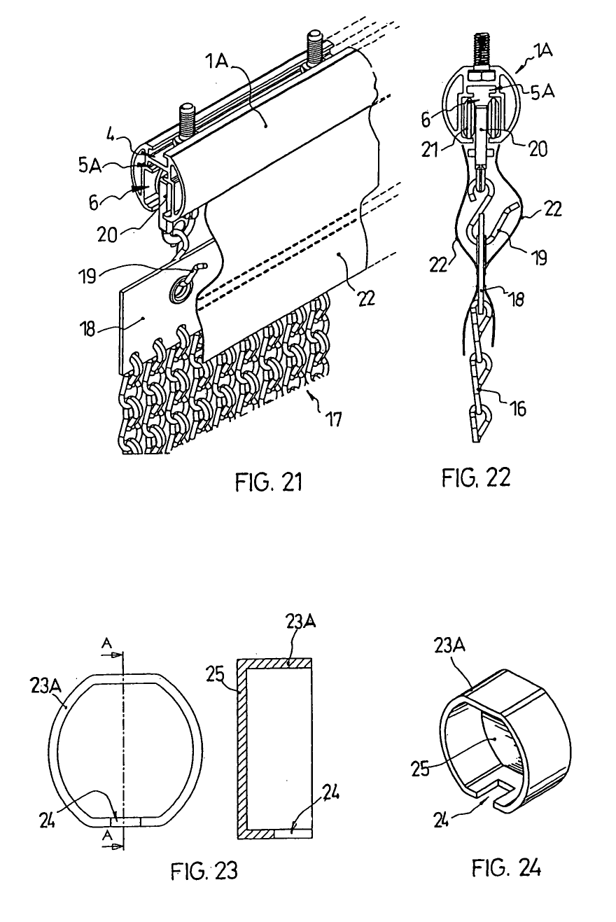

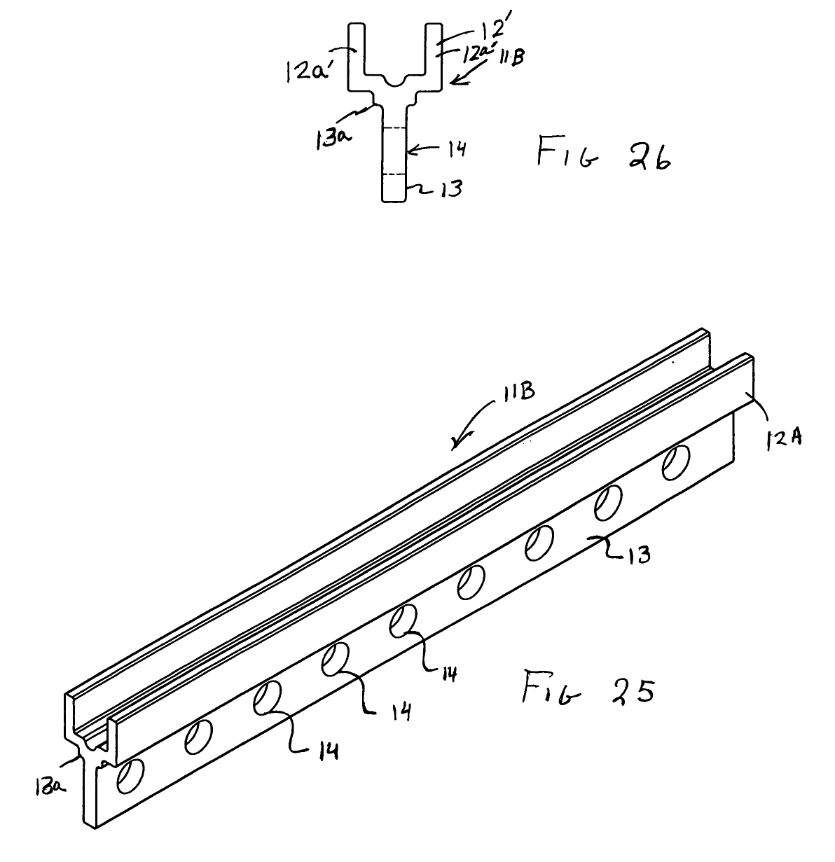

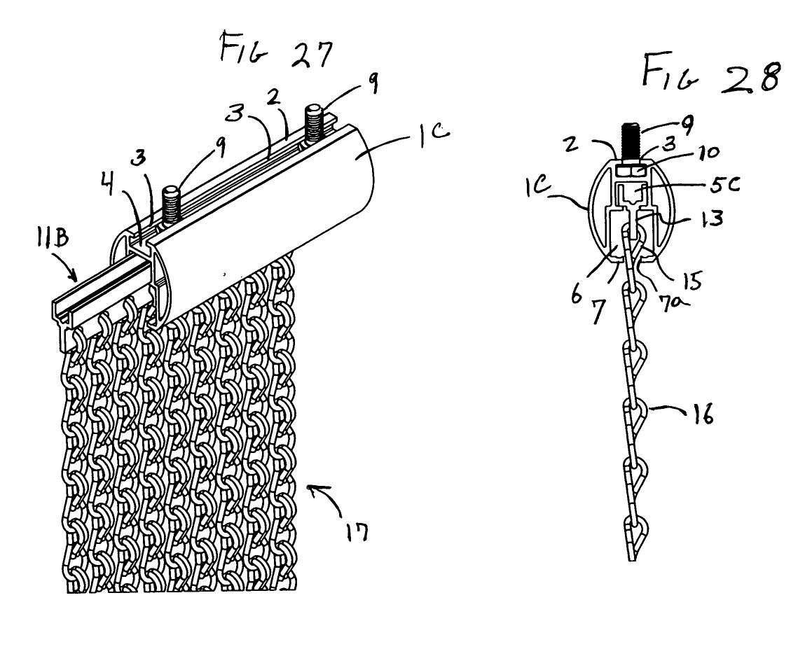

With primary reference to the embodiments FIGS. 13-24, structural modifications and features defining this additional preferred embodiment include the mounting rail 1a having common structural features as the mounting rail 1 in the embodiment of FIG. 1 differing in dimensional and configurational aspects as set forth in greater detail hereinafter. More specifically, the hollow interior of the mounting rail 1a is also defined by a plurality of at least two elongated chambers 5a and 6 extending along the length of the mounting rail 1a and disposed in adjacent, communicating relation to one another.

Similarly at least one support member 11a is structured to be disposed in an operative position within the hollow interior of the mounting rail 1 and as such includes a head portion 12a and a fixedly attached leg portion 13. Leg portion 13 has the aforementioned apertured construction as defined by the plurality of spaced apart apertures 14 used to connect the curtain 17 in a hanging orientation as described above. However, different structural features of the embodiment of FIGS. 13-24 include the head portion 12a of the support member 11a having a different dimension and shape from the head portion 12 of the one support element 11 of the embodiment of FIG. 3. More specifically, the support member 11 including the fixedly attached head portion 12 and leg portion 13 can be more accurately described as having a substantially Y-shaped cross sectional configuration. In contrast, the support element 11a of the embodiment of FIG. 15 may include a head portion 12a and a leg portion 13 having a substantially T-shaped configuration. The primary difference in the dimension and configuration in the head portions 12 and 12a of the embodiments of FIGS. 3 and 15 is the overall weight of the curtain or shades 17 which is intended to be connected to and supported by the respective support elements 11 and 11a. More specifically the somewhat enlarged head portion 12 of the support element 11 is intended to support a generally heavier weighted curtain or shade 17 and as such the enlarged head portion 12 being correspondingly configured to the cross sectional configuration of the channel 5 is supported in its operative orientation in a stable and secure manner.

However, the somewhat smaller head portion 12a of the support element 11 extends transversely or laterally outward from the upper end of the leg portion 13 and as such is dimensioned and configured to fit within a correspondingly dimensioned and configured chamber 5a. Therefore, the support element 11a and the cooperative physical characteristics of the dimensions and configurations of the head portion 12a relative to the receiving, corresponding chamber 5a is such as to typically support a lighter weight curtain or shade 17.

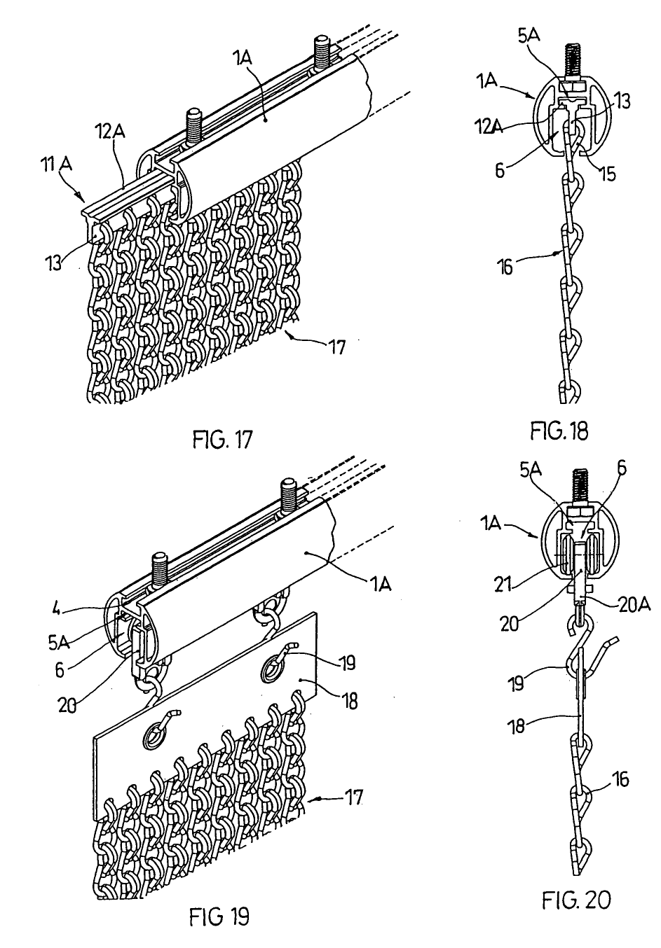

With primary reference to the embodiments of FIGS. 19-22, without the support element 11a in the operative position of FIGS. 17 and 18, the adjacent, communicating chamber 6 is dimensioned and configured to receive the carriage type support member 20, as explained in detail with specific reference to FIGS. 8-10.

Yet another preferred embodiment of the present invention is represented in FIGS. 26-28 and differs structurally from the embodiments of FIGS. 1-5 through the provision of a head portion 12′ having a substantially Y-shaped configuration but being structurally distinguishable from the head portion 12 of the embodiment of FIGS. 3 and 4. More specifically, the head portion 12′ includes two upwardly extending lateral sides 12a′ and is absent the aforementioned inwardly directed flanges 12b as evident in FIG. 4. However, the elongated chamber 5c still defines the hollow interior portion of the mounting rail 1c and is disposed in adjacent, communicating relation to the somewhat larger chamber 6. As clearly represented in FIG. 28, the receiving chamber 5c is correspondingly dimensioned and configured to that of the head portion 12′ so as to effectively receive the head portion 12′ therein.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A support assembly for a curtain comprising:
a mounting assembly structured to be connected to a supporting structure and including an elongated rail having an at least partially hollow interior extending along the length thereof,
said hollow interior comprising a plurality of elongated chambers extending along the length of said rail,
a support assembly including at least one elongated support member disposable in an operative position within said hollow interior,
said operative position comprising said support member connected in supporting relation to the curtain, and
said operative position further comprising said support member disposed in a supporting, non-exposed position within a corresponding one of said plurality of chambers.

2. A support assembly as recited in claim 1 wherein the support member comprises a head portion disposed within said corresponding one of said plurality of chambers and a leg portion connected in supporting relation to the curtain.

3. A support assembly as recited in claim 2 wherein said corresponding one of said plurality of chambers substantially corresponds in dimension and configuration to said head portion.

4. A support assembly as recited in claim 3 wherein said substantially corresponding dimension and configuration of said corresponding one chamber and said head portion are at least partially dependent on a weight of the curtain connected to the leg portion.

5. A support assembly as recited in claim 1 wherein said plurality of chambers includes two adjacent chambers disposed in communicating relation with one another.

6. A support assembly as recited in claim 5 wherein one of said two chambers substantially corresponds in dimension and configuration to said head portion.

7. A support assembly as recited in claim 6 wherein said operative position comprises said head portion disposed within said one chamber and said leg portion extending through the other of said two chambers.

8. A support assembly as recited in claim 7 wherein said operative position further comprises said head portion and said leg portion disposed in a non-exposed position within said hollow interior.

9. A support assembly as recited in claim 5 wherein said operative position comprises said head portion disposed within said one chamber and said leg portion extending through the other of said two chambers.

10. A support assembly as recited in claim 9 wherein said other of said two chambers is disposed and structured to receive an auxiliary support member therein, absent said support member being disposed in said operative position.

11. A support assembly as recited in claim 10 wherein said other chamber comprises a sufficiently large cross sectional configuration to reciprocally support the auxiliary support member therein.

12. A support assembly as recited in claim 1 wherein said rail includes an open lower channel extending along the length of said rail and disposed in communicating relation between an exterior of said rail and a next adjacent one of said plurality of chambers.

13. A support assembly as recited in claim 12 wherein said open lower channel is disposed and structured to facilitate passage disposition of the curtain therethrough from supported connection with said support member to the exterior of said rail, when said support member is disposed in said operative position.

14. A support assembly as recited in claim 13 further comprising an open upper channel extending along the length of an upper portion of the said rail, said open upper channels disposed and structured to receive and retain a connecting assembly therein whereby the connecting assembly interconnects said mounting assembly to the supporting structure.

15. A support assembly as recited in claim 14 wherein said open upper channel includes an elongated slot disposed in communicating relation between an exterior of said rail and an interior of said open upper channel.

16. A support assembly as recited in claim 15 wherein said elongated slot and open upper channel are cooperatively dimensioned with said connecting assembly to facilitate extension of the connecting assembly through said open slot and concurrent retaining engagement of the connecting assembly within said open upper channel.

17. A support assembly as recited in claim 1 further comprising an open upper channel extending along the length of an upper portion of the said rail, said open upper channels disposed and structured to receive and retain a connecting assembly therein whereby the connecting assembly interconnects said mounting assembly to the supporting structure.

18. A support assembly as recited in claim 17 wherein said open upper channel includes an elongated slot disposed in communicating relation between an exterior of said rail and an interior of said open upper channel.

19. A support assembly as recited in claim 16 wherein said elongated slot and open upper channel are cooperatively dimensioned with said connecting assembly to facilitate extension of the connecting assembly through said open slot and concurrent retaining engagement of the connecting assembly within said open upper channel.

20. A support assembly as recited in claim 1 wherein said support member includes an enlarged head portion and a leg portion fixedly connected thereto and extending transversely outward therefrom.

21. A support assembly as recited in claim 20 wherein said corresponding one of said plurality of chambers substantially corresponds in dimension and configuration to said head portion.

22. A support assembly as recited in claim 21 wherein said leg portion comprises an apertured construction structured to facilitate connection of a plurality of components of the curtain in supported, depending relation to said support member.

23. A support assembly as recited in claim 22 wherein said apertured construction comprises a plurality of apertures formed in said leg portion and extending along the length of said support member.

24. A support assembly as recited in claim 21 wherein said head portion and said leg portion are relatively disposed to collectively define a substantially Y-shaped configuration.

25. A support assembly as recited in claim 21 wherein said head portion and said leg portion are relatively disposed to collectively define a substantially T-shaped configuration.

26. A support assembly for hanging a chain curtain which includes a plurality of elongated strings of chain links supported in depending, side by side relation to one another, said support assembly comprising:
a mounting assembly structured to be connected to a supporting structure and including an elongated rail having an at least partially interior extending along the length thereof,
said hollow interior comprising two elongated chambers disposed in communicating relation with one another and extending along the length of said rail,
a support assembly including at least one elongated support member disposable in an operative position within said hollow interior,
said support member including a head portion and a leg portion fixedly secured to one another, and
said operative position comprising said leg portion connected in supporting relation to the plurality of strings and said head portion disposed within a correspondingly dimension one of said two chambers.

27. A support assembly as recited in claim 26 wherein said operative position comprises said leg portion disposed within the other of said two chambers in connected, supporting engagement with the plurality of strings.

28. A support assembly as recited in claim 27 wherein said operative position further comprises said head portion and said leg portion disposed in an exteriorly non-exposed position within said hollow interior of said rail.

29. A support assembly as recited in claim 26 further comprising a cover assembly connected to said rail and disposed in covering relation to exposed portions of the curtain disposed adjacent said rail.

30. A support assembly as recited in claim 29 wherein said cover assembly comprises a plurality of cover members each of at least two of said cover members disposed on opposite sides of the curtain.
